(19) United States
(12) Patent Application Publication
(10) Pub. No.: US 2025/0147289 A1
(43) Pub. Date: May 8, 2025

(54) Infrared Objective Lens with Curved Focal Surface

(71) Applicant: The Government of the United States, as represented by the Secretary of the Army, Washington, DC (US)

(72) Inventor: John M. Hall, Stafford, VA (US)

(21) Appl. No.: 18/386,697

(22) Filed: Nov. 3, 2023

(51) Int. Cl. G02B 13/14; G02B 27/00

(52) U.S. Cl. CPC G02B 13/14; G02B 27/0056

(57) ABSTRACT

A low-cost objective lens design uses only ZnS optical material, suitable for use with an uncooled infrared bolometer having a curved focal plane. Its objective lens field of view is at least ±20.0° over a 1280×720 pixel array with 0.0012 mm pitch. Lens chromatic aberrations are corrected over at least the 8-11 micron infrared wavelength band. The objective lens operates at a relatively fast F #/1.0 which is common in the art for bolometer applications.

### GOVERNMENT INTEREST

The invention described herein may be manufactured, used, sold, imported, and/or licensed by or for the Government of the United States of America.

### FIELD OF THE INVENTION

The invention relates to an infrared objective lens.

### BACKGROUND ART

The low-cost infrared thermal imaging market is dominated by “uncooled” sensor assemblies which include optical objective lenses that focus an image onto a bolometer focal plane detector array, which then in turn converts the optical image into electronic signals. The standard spectral waveband for such sensors is 8-12 microns for the wavelength of light. A typical infrared objective lens assembly for a wide-field of view of ±20.0° and fast F # on the order of 1.0-1.2 requires at least two lens singlets (Latimer & Fantozzi), of which at least one is typically made out of Germanium lens material. See, e.g., David G. Latimer and Louis R. Fantozzi, “Fast 8-12 m Objectives Utilizing Multiple Aspheric Surfaces”, SPIE Conference on Infrared Technology and Applications XXV, 882 Orlando, Florida, April 1999 SPIE Vol. 3698, 0277-786×1991, which shows standard two-lens Ge design forms for most uncooled applications.

It has been noted that field curvature is a significant optical aberration for these wide field, fast-F # objective lens design forms (Schuster & Franks). See, Norbert Schuster, John Franks, “Two-lens designs for modern uncooled and cooled IR imaging devices,” Proc. SPIE 8896, Electro-Optical and Infrared Systems: Technology and Applications X, 889604, 25 Oct. 2013; doi: 10.1117/12.2028716, wherein field curvature is primary aberration of concern for WFOV lens. Desroches, et. al., provided a list of infrared materials and their relative cost compared to Germanium as the common baseline. See, Gerard Desroches, Kristy Dalzell, Blaise Robitaille, “Technical considerations for designing low-cost, long-wave infrared objectives,” Proc. SPIE 9070, Infrared Technology and Applications XL, 907026 (24 Jun. 2014); doi: 10.1117/12.2050570. Their results indicate that Zinc Sulphide (ZnS) is perhaps the most affordable material overall. However, attempts to create designs which do not use high-index material such as Ge in lieu of cheaper materials such as ZnS typically result in more than two lenses being required (Zang, et. al.), thereby negating the potential for cost reduction. See, Evan Zhang, Vivian W. Song, James S. Zhang, Cunwu Yang, “Non-Ge optics and low-cost electronics designs for LIR imagers,” Proc. SPIE 4820, Infrared Technology and Applications XXVIII, (23 Jan. 2003); doi: 10.1117/12.469690, which taught non-Ge solution required three fat lenses, best solution was Ge & AMTIR-1.

Recently, the ability to fabricate infrared bolometer focal arrays upon curved instead of traditionally flat substrates has been demonstrated (Fendler, et. al.), with the implications that if the focal plane curvature matches the normal amount of optical field curvature, then the burden upon the lens design of correcting field curvature is reduced or possibly eliminated. See, M. Fendler, D. Dumas, F. Chemla, M. Cohen, P. Laporte, K. Tekaya, E. Le Coarer, J. Primot, H. Ribot, “Hemispherical infrared focal plane arrays: a new design parameter for the instruments,” Proc. SPIE 8453, High Energy, Optical, and Infrared Detectors for Astronomy V, 84531P (25 Sep. 2012); doi: 10.1117/12.925379.

It is therefore the purpose of the present invention to demonstrate that indeed the mitigation of field curvature considerations permits the use of alternative lower cost materials without adding extra lens components as compared to the current art.

### SUMMARY OF THE INVENTION

The subject invention is a novel low-cost objective lens design, using only ZnS optical material, suitable for use with an uncooled infrared bolometer having a curved focal plane. The objective lens field of view is at least ±20.0° over a 1280×720 pixel array with 0.0012 mm pitch. Lens chromatic aberrations are corrected over at least the 8-11 micron infrared wavelength band. The objective lens operates at a relatively fast F #/1.0 which is common in the art for bolometer applications.

An exemplary optical system uses a single material ZnS for two lenses, each lens having aspheric curvatures on both faces, resulting in a low positive power (≈5 diopter) from the first lens and stronger positive power (≈35 diopter) from the second lens. Each lens has a negative-power diffractive surface on its 2nd surface to provide correction of chromatic aberrations for a focal plane having a concave radius of curvature.

Thus, subject invention demonstrates that indeed the mitigation of field curvature considerations permits the use of alternative lower cost materials without adding extra lens components as compared to the current art.

### BRIEF DESCRIPTION OF DRAWINGS

Additional advantages and features will become apparent as the subject invention becomes better understood by reference to the following detailed description when considered in conjunction with the accompanying drawings wherein:

FIG. 1 shows light rays entering an exemplary optical system.

FIG. 2 shows an exemplary root-mean-square value of the total wavefront error as a function of position within a field of view of the exemplary optical system.

### DETAILED DESCRIPTION

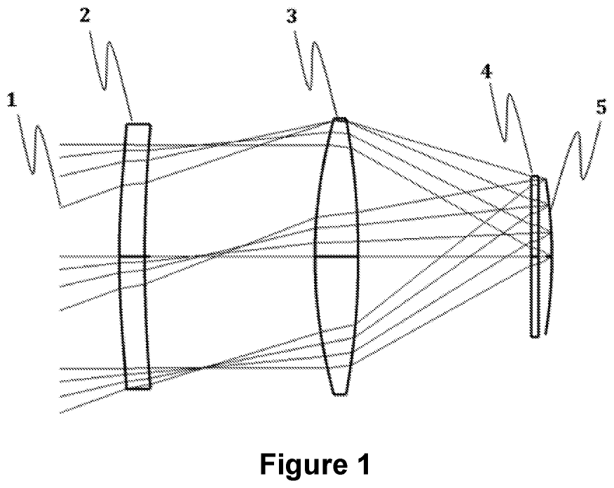

The subject invention is a novel low-cost objective lens design, using only ZnS optical material, suitable for use with an uncooled infrared bolometer having a curved focal plane. The objective lens field of view is at least ±20.0° over a 1280×720 pixel array with 0.0012 mm pitch. Lens chromatic aberrations are corrected over at least the 8-11 micron infrared wavelength band. The objective lens operates at a relatively fast F #/1.0 which is common in the art for bolometer applications. The description of the invention is best explained via reference to FIG. 1 below.

Light rays 1 enter the optical system from four very distant object points. The first optical element 2 provides a weak positive power of 5.15 diopters, and is made using Zinc Sulphide (ZnS) infrared transmitting material with a diameter of at least 28 mm. The first surface of element 2 has an aspherical curvature to enable correction of higher order optical aberrations. The second surface of element 2 has a hybridized surface profile containing both an aspheric base curvature with an overlaid diffractive pattern. The light rays progress over an intervening air gap and are incident upon the second lens element 3 which provides a strong optical power of 35.26 diopters and is also made from ZnS optical material with a diameter of at least 30.5 mm. The first surface of element 3 has an aspherical curvature to enable correction of higher order optical aberrations. The second surface of element 3 has a hybridized surface profile containing both an aspheric base curvature with an overlaid diffractive pattern. In each case of an aspheric surface, the profile is defined by the standard optical equation as follows where z is the surface sag, c is the curvature, r is the radial height above the optical axis, k is the conic constant, and then α₁, α₂, etc. are the aspheric coefficients:

$$z = [ ( {cr}^{2} ) \div ( 1 + S Q R T ( 1 - ( 1 + k ) {c}^{2} {r}^{2} ) ) ] + {α}_{1} {r}^{4} + {α}_{2} {r}^{6} + {α}_{3} {r}^{8} + {α}_{4} {r}^{10} + {α}_{5} {r}^{12} + {α}_{6} {r}^{14} + {α}_{7} {r}^{16} .$$

In the instances where diffractive surfaces are present, the diffractive profile adds phase (i.e., effective sag) to the raytrace per the following relationship where ϕ is the added phase, M is diffraction order, n is the whole number count of terms in the equation, the Aₙ are coefficients, and ρ is the normalized radial aperture coordinate:

ϕ=MΣₙAₙρ²ⁿ.

In the preferred embodiment, the maximum order polynomial for ϕ is n=2, with the n=1 terms being negative, n=2 terms having positive values of lesser magnitude. The diffractive phase profiles thus have a net negative power for each of element 2 and 3, thereby providing a large degree of correction for color aberrations across the infrared spectrum from 8-11 micron wavelengths. After being acted upon by the two lens elements 2 and 3, the light rays 1 pass through a flat window 4 and then come to a focus onto a curved focal plane 5. The curved focal plane 5 has a concave radius of curvature of roughly 52.5 mm, and thus relieves the lens design from having to correct field flatness aberrations.

Accordingly, an exemplary optical system uses a single material ZnS for both lenses, each lens 2 & 3 having aspheric curvatures on both faces, resulting in a low positive power (≈5 diopter) from the first lens and stronger positive power (≈35 diopter) from the second lens. Each lens 2 & 3 have a negative-power diffractive surface on the 2nd surface to provide correction of chromatic aberrations, forming a focal plane with a concave radius of curvature.

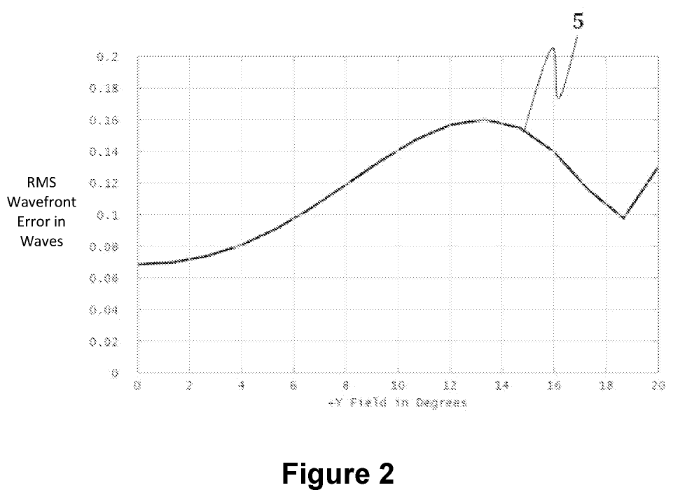

The total level of aberration correction and focused image quality of the preferred embodiment is captured in FIG. 2, which shows the root-mean-square (RMS) value of the total wavefront error as a function of position within the field of view. The results indicate the nominal design performance is close to the diffraction limit over most of the field.

It is obvious that many modifications and variations of the present invention are possible in light of the above teachings. It is therefore to be understood that within the scope of the appended claims, the invention may be practiced otherwise than as described.

1. An optical system, comprising:
a first optical element based on a ZnS optical material having a diameter of at least 28 mm, wherein a first surface of the first optical element has an aspherical curvature to enable correction of higher order optical aberrations, and wherein a second surface of the first optical element has a hybridized surface profile of an aspheric base curvature with an overlaid diffractive pattern;
a second lens element based on the ZnS optical material having a diameter of at least 30.5 mm, wherein a first surface of the second lens element has an aspherical curvature to enable correction of higher order optical aberrations, and wherein a second surface of the second lens element has a hybridized surface profile of an aspheric base curvature with an overlaid diffractive pattern; and
a flat window disposed to have a first flat surface of the flat window face the second surface of the second lens element, wherein, an opposing flat surface of the flat window faces a curved focal plane, and wherein the curved focal plane is characterized by a concave radius of curvature of roughly 52.5 mm to obviate a need to correct field flatness aberrations.

2. The optical system according to claim 1, wherein an aspheric surface of said first optical element has a profile defined by a standard optical equation,
$$z = [ ( {cr}^{2} ) \div ( 1 + S Q R T ( 1 - ( 1 + k ) {c}^{2} {r}^{2} ) ) ] + {α}_{1} {r}^{4} + {α}_{2} {r}^{6} + {α}_{3} {r}^{8} + {α}_{4} {r}^{10} + {α}_{5} {r}^{12} + {α}_{6} {r}^{14} + {α}_{7} {r}^{16} ,$$
wherein z is a surface sag, c is a curvature, r is a radial height above an optical axis, k is a conic constant, and α₁, α₂, α₃, α₄, α₅, α₆, and α₇ are aspheric coefficients.

3. The optical system according to claim 1, wherein an aspheric surface of said second lens element has a profile defined by a standard optical equation,
$$z = [ ( {cr}^{2} ) \div ( 1 + S Q R T ( 1 - ( 1 + k ) {c}^{2} {r}^{2} ) ) ] + {α}_{1} {r}^{4} + {α}_{2} {r}^{6} + {α}_{3} {r}^{8} + {α}_{4} {r}^{10} + {α}_{5} {r}^{12} + {α}_{6} {r}^{14} + {α}_{7} {r}^{16} ,$$
wherein z is a surface sag, c is a curvature, r is a radial height above an optical axis, k is a conic constant, and α₁, α₂, α₃, α₄, α₅, α₆, and α₇ are aspheric coefficients.

4. The optical system according to claim 1, wherein said first optical element provides a weak positive power of 5.15 diopters.

5. The optical system according to claim 1, wherein said ZnS optical material is an infrared transmitting material based on Zinc Sulphide.

6. The optical system according to claim 1, wherein said second lens element provides a strong optical power of 35.26 diopters.

7. The optical system according to claim 1, wherein an air gap separates the second surface of said first optical element and the first surface of said second lens element.

8. The optical system according to claim 1, wherein said optical system is an infrared objective lens arrangement suitable for use with an uncooled infrared bolometer having a curved focal plane.

9. The optical system according to claim 8, wherein its objective lens field of view is at least ±20.0° over a 1280×720 pixel array with 0.0012 mm pitch.

10. The optical system according to claim 8, wherein lens chromatic aberrations are corrected over at least the 8-11 micron infrared wavelength band.

11. The optical system according to claim 8, wherein said optical system can operate at a relatively fast F #/1.0 for bolometer applications.

12. A method of focusing light rays onto a curved focal plane using the optical system according to claim 1, the method comprising the steps of:
directing distant light rays toward a first surface of a first optical element to transmit through a ZnS infrared transmitting material of said first optical element, wherein said first surface of the first optical element has an aspherical curvature to enable correction of higher order optical aberrations;
said distant light rays as transmitted through said first optical element are emitted from a second surface of the first optical element, which second surface of the first optical element has a hybridized surface profile of an aspheric base curvature with an overlaid diffractive pattern;
said emitted light rays from said second surface of the first optical element progress over an intervening air gap and are incident upon a first surface of a second lens element to transmit through a ZnS optical material of said second lens element, wherein said first surface of the second lens element has an aspherical curvature to enable correction of higher order optical aberrations of light rays that are transmitted;
said light rays transmitted through the second lens element are emitted from a second surface of said second lens element, wherein said second surface of the second lens element has a hybridized surface profile of an aspheric base curvature with an overlaid diffractive pattern; and
said emitted light rays from said second surface of said second lens element are passed through a flat window to come to a focus onto a curved focal plane, wherein said curved focal plane has a concave radius of curvature to obviate a need to correct field flatness aberrations.

13. The method of focusing light rays onto a curved focal plane according to claim 12, wherein said first optical element has a diameter of at least 28 mm.

14. The method of focusing light rays onto a curved focal plane according to claim 12, wherein said second lens element has a diameter of at least 30.5 mm.

15. The method of focusing light rays onto a curved focal plane according to claim 12, wherein said curved focal plane has a concave radius of curvature of roughly 52.5 mm.

16. The method of focusing light rays onto a curved focal plane according to claim 12, wherein an air gap separates the first optical element and the second lens element.

17. The method of focusing light rays onto a curved focal plane according to claim 12, wherein the second surface of said first optical element has a diffractive phase profile which adds phase or effective sag to a raytrace per the following equation,
ϕ=MΣₙAₙρ²ⁿ,
wherein ϕ is the added phase, M is diffraction order, n is a whole number count of terms in the equation, Aₙ are coefficients, and ρ is a normalized radial aperture coordinate.

18. The method of focusing light rays onto a curved focal plane according to claim 17, wherein a maximum order polynomial for ϕ is n=2, with n=1 terms being negative, n=2 terms having positive values of lesser magnitude, whereby the diffractive phase profile has a net negative power, providing a large degree of correction for color aberrations across an infrared spectrum from 8-11 micron wavelengths.

19. The method of focusing light rays onto a curved focal plane according to claim 12, wherein the second surface of said second lens element has a diffractive phase profile which adds phase or effective sag to a raytrace per the following equation,
ϕ=MΣₙAₙρ²ⁿ,
wherein ϕ is the added phase, M is diffraction order, n is a whole number count of terms in the equation, Aₙ are coefficients, and ρ is a normalized radial aperture coordinate.

20. The method of focusing light rays onto a curved focal plane according to claim 19, wherein a maximum order polynomial for ϕ is n=2, with n=1 terms being negative, n=2 terms having positive values of lesser magnitude, whereby the diffractive phase profile has a net negative power, providing a large degree of correction for color aberrations across an infrared spectrum from 8-11 micron wavelengths.
